(19) United States
(12) Patent Application Publication
(10) Pub. No.: US 2008/0096182 A1
(43) Pub. Date: Apr. 24, 2008

(54) Display kit and method of constucting same

(76) Inventor: C. Dwayne Fulton, Osage Beach, MO (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 11/582,674

(22) Filed: Oct. 18, 2006

(51) Int. Cl. G09B 25/00

(52) U.S. Cl. 434/365

(57) ABSTRACT

A kit useful by hobbyist and students in constructing displays and dioramas. The kit comprises a base formed from integral sidewalls and a top which presents a planar surface. A channel is formed around the periphery of the planar surface. The kit further includes a backboard which is foldable into a generally planar configuration and has a width greater than the width of the channel. The backboard is wedged into the channel and will remain in place without the use of external fasteners. The backboard is received in the channel on at least three sides of the base. The backboard is formed from a material so that it can be cut to present a desired configuration. A method of constructing a display kit comprises placing the base on a flat surface, at least partially unfolding the backboard to conform on the configuration of the base on at least three sides and then securing the backboard to the base without the use of external fasteners.

### BACKGROUND OF THE INVENTION

This invention relates generally to displays for use by hobbyist and for educational purposes. More particularly, the invention relates to kits which include a base and a backboard which can be packaged and shipped flat and then joined together without the use of external fasteners to present a three dimensional display.

It is well known to construct three dimensional displays having a base and a backboard for constructing dioramas and for displaying collectibles and other objects.

### BRIEF SUMMARY OF THE INVENTION

The display according to the present invention includes a base which presents a planar surface and a backboard adapted to be coupled with the base on at least three sides while being foldable into a planar configuration. The base includes a channel for receiving the backboard which is wedged into the channel so that the backboard is supported without the use of external fasteners.

The invention also encompasses a method of constructing a display from a kit comprising a base and a backboard that is packaged with the base in a flat folded configuration. The method comprises the steps of placing the base on a flat surface, at least partially unfolding the backboard to conform to the configuration of the base on at least three sides and securing the backboard to the base without the use of external fasteners.

### BRIEF DESCRIPTION OF THE DRAWINGS

In the drawings:

FIG. 1 is a perspective view of the display kit in assembled form;

FIG. 2 is a perspective view of the display kit in use to hold an educational presentation;

FIG. 3 is another perspective view of the display kit use to present a diorama;

FIG. 4 is a greatly enlarged cross sectional view of the base and backboard illustrating the preferred manner for fastening the backboard to the base;

FIG. 5 is an exploded perspective view illustrating the way in which the backboard is folded and unfolded.

FIG. 6 illustrates the backboard in its folded planar configuration; and

FIG. 7 illustrates the backboard being cut by a knife into a desired configuration.

### DETAILED DESCRIPTION OF PREFERRED EMBODIMENT

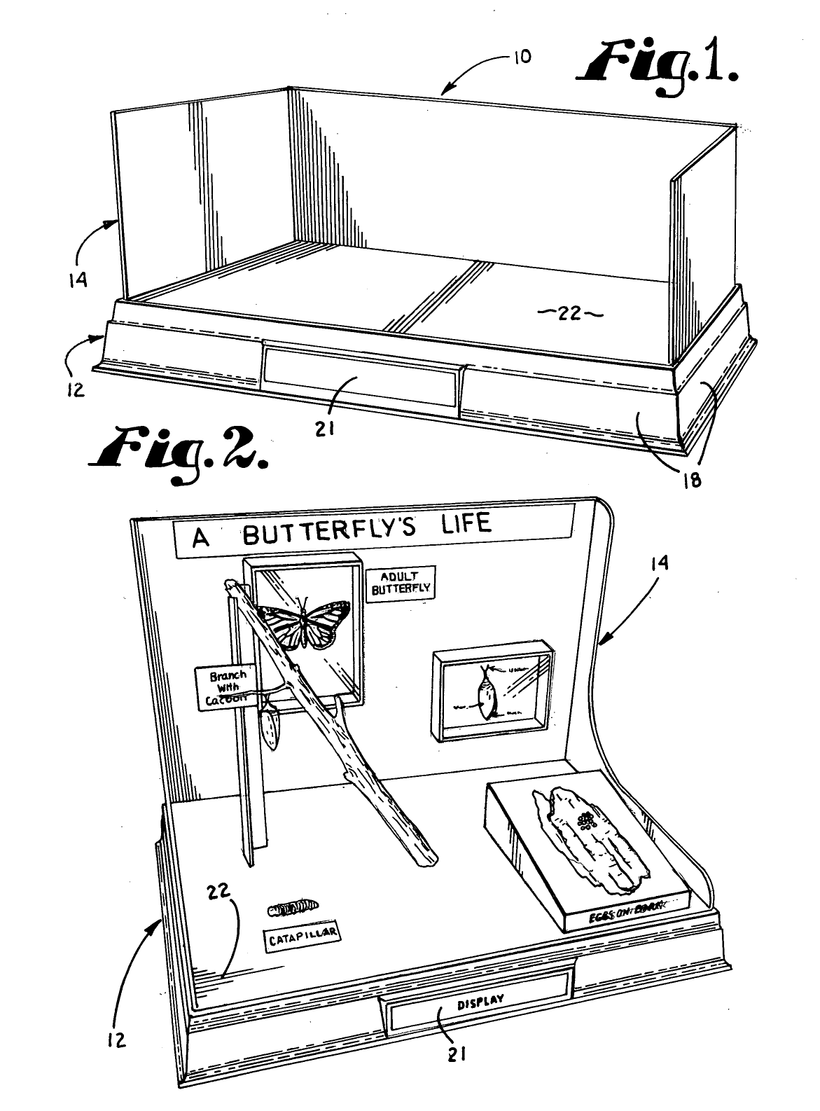

Referring initially to FIG. 1, the display kit according to the present invention is designated generally by the numeral 10 and includes a base 12 and a backboard 14.

With reference to FIG. 4, base 12 is formed from a unitary sheet of plastic and includes a bottom rim 16, integral sidewalls 18 and an integral planar top 20 which presents a planar surface 22. In the embodiment illustrated in FIG. 4 it is to be noted that surface 22 is a rough surface which may be integrally molded or formed by other means. It is also within the scope of the invention for surface 22 to be smooth. Sidewalls 18 are formed in a non-planar configuration with a first curvilinear surface 18a which is integral with bottom rim 16 and a second curvilinear surface 18b which joins the main wall section 18 to an upper wall section 18c which is then integral with top 20. Front sidewall 18 includes a flat rectangular portion 21 which is used for a name plate as indicated in FIG. 2.

In use, the display kit 10 is normally sold with base 12 and backboard 14 packaged as a unit. Backboard 14 is, of course, packaged in its folded planar configuration as illustrated in FIG. 6 so that the entire package is relatively flat. A user will remove the backboard from the package and at least partially unfold it to conform to the shape of base 12. The backboard is then wedged into channel 24 which firmly holds it in place relative to the base without the need for auxiliary fasteners of any kind. In this regard, the depth of channel 24 is sufficient to receive enough of backboard 14 (generally 1% to 5% of the total height) so that the backboard will hold without the use of any additional fastener. It is to be understood, of course, that while the invention encompasses a backboard which is held on the base without the utilization of any auxiliary mechanical fasteners, it is within the scope of the invention to apply an adhesive to channel 24 to facilitate retention of the backboard within the channel. The display is then ready for use.

Alternatively, it may be desirable to position the backboard 14 on a flat surface and cut it to a desired shape utilizing a sharp knife. The is illustrated in FIG. 7 with the resulting application illustrated in FIG. 2. Referring to FIG. 2, it is to be noted that backboard 14, though reduced in size through the cutting step, still engages channel 24 on at least three sides of base 12. This provides the desired rigidity and stability to both the base and the backboard.

The rough finish of planar surface 22 (FIG. 4.) facilitates adhesively securing objects such as those illustrated in FIG. 2 to the surface. Manifestly, the objects displayed in FIG. 2 represent the life of a butterfly with appropriate actual specimens.

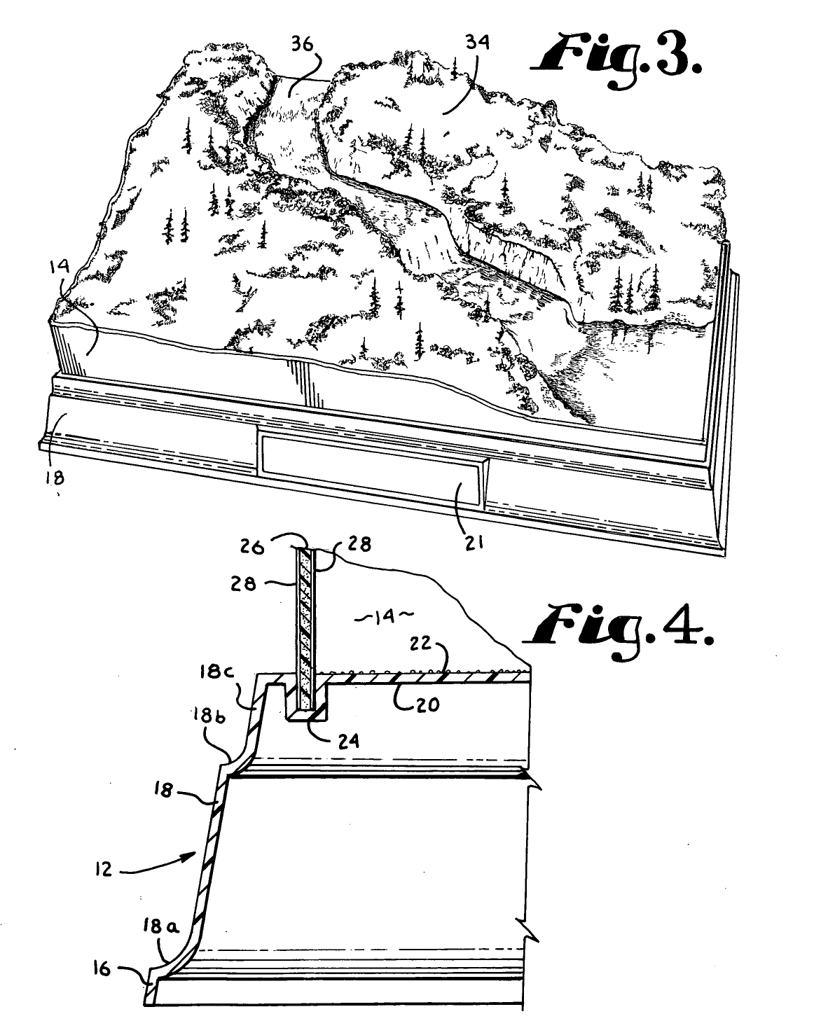

Another application of the display kit 10 according to the present invention is illustrated in FIG. 3. Here a three dimensional diorama 34 is presented which includes a tree covered terrain 34 and a simulated waterfall 36. Backboard 14 is cut in the manner previously described to form the outline of the terrain which is then built within the perimeter of the backboard in a manner well known to those skilled in the art. This includes forming a base of crumpled newspaper which is overlaid with plaster cloth and simulated vegetation is applied. The simulated waterfall is formed utilizing a liquid polymer which dries to a solid. It is to be understood that utilizing a section of backboard 14 on all four sides of base 18, such as when a diorama as illustrated in FIG. 3 is presented, is within the scope of the present invention.

While the backboard has been described as having a rigid foam core sandwiched between two laminates 28, it is be understood that the backboard can be formed from a wide variety of materials so long as it is foldable into a planar configuration. For example, a unitary foam board which has an integral skin formed on the side could be utilized as well as a paper board such as cardboard. Other materials which may be utilized for backboard 14 include rigid plastic, extruded styrofoam, and urethane foam. All of these materials may be formed with or without a laminate surface although the sandwiched foam core between two laminates 28 as shown is the preferred construction.

It is also within the scope of the invention to provide a base 18 which has multiple planar surfaces at different levels. In this instance, backboard 14 would be shipped inside of base 18 in its folded configuration.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

Walls 18 and top 20 cooperate to form a u-shaped channel 24 which extends around the periphery of surface 22. Channel 24 has a width which is slightly less than the width of backboard 14.

Still referring to FIG. 4, backboard 14 is formed with a rigid foam center 26 which is sandwiched between laminate layers 28 that present the inner and outer surfaces of the backdrop. As previously noted, the width of backboard 14 is slightly greater than the width of channel 24 and the backboard so that the latter can be wedged in the channel for a tight fit.

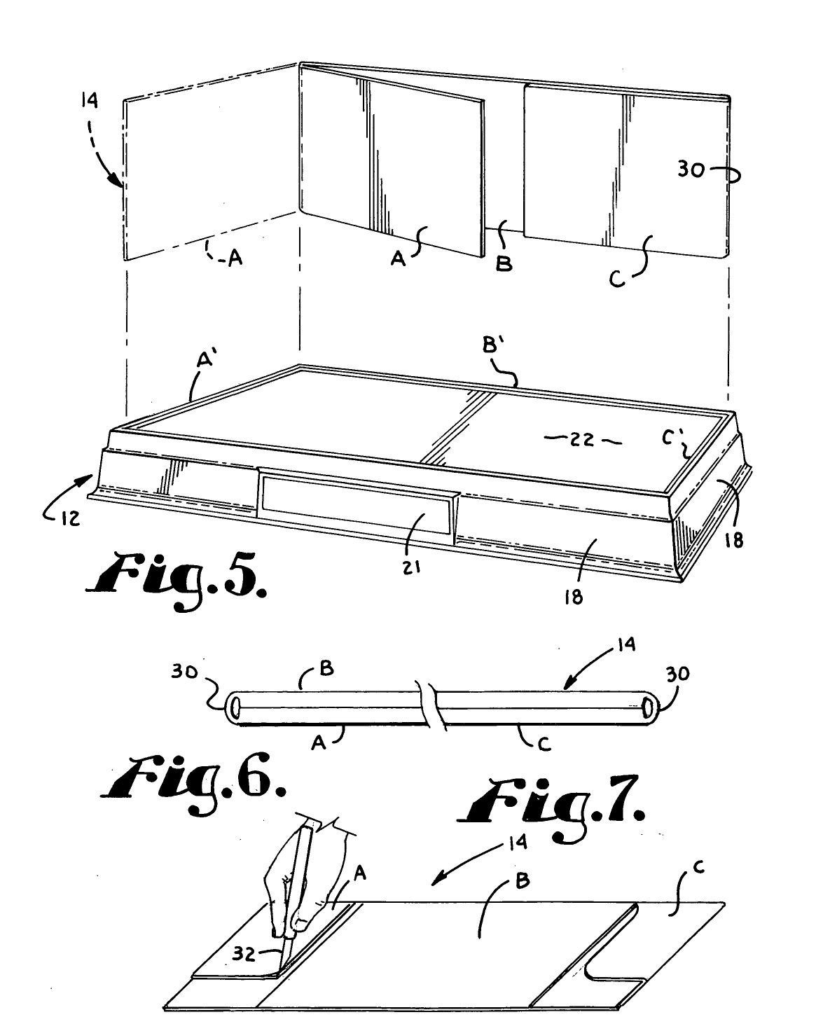

As illustrated in FIGS. 1 and 5, backboard 14 is constructed with a total length equal to the length of three sides of base 12. It is also provided with lines of weakness 30 which divide the backboard into three sections, A, B and C which correspond in length to three sides a¹, B¹ and C¹ of base 12. The lines of weakness allow backboard sections A thru C to be placed on base 12 and conform to the length of three sides of the base while still remaining unitary. Furthermore, the lines of weakness accommodate folding of backboard 12 into the planar configuration shown in FIG. 6.

Walls 18 are constructed in a non-planar configuration for aesthetic reasons as well as to facilitate its removal from a mold and so that the curvilinear surfaces 18a and 18b will add strength and rigidity to the overall base. In this regard, it will be appreciated that channel 24, while serving as the means for coupling the backboard with the base, also provides strength and rigidity to the base.

Backboard 14 is constructed so that it can be placed on a flat surface and completely unfolded as illustrated in FIG. 7. In this manner, the backboard can be cut with a knife 32 into a desired configuration such as the configuration illustrated in FIG. 2.

What is claimed and desired to be secured by Letters Patent is as follows:

1. A display comprising:
a base presenting a planar surface; and
a backboard adapted to be coupled with said base on at least three sides while being foldable into a planar configuration.

2. The invention in claim 1, wherein said backboard is adapted to be coupled with said base without the use of external fasteners.

3. The invention of claim 1, wherein said base includes a channel for receiving said backboard.

4. The invention of claim 3, wherein the width of said backboard is greater than the width of said channel, said backboard being wedged into said channel.

5. The invention of claim 1, wherein said backboard is rigid and comprises a material which can be cut with a knife to present a desired configuration.

6. The invention of claim 5, wherein said backboard is comprised of a rigid foam.

7. The invention of claim 6, wherein said rigid foam includes a laminate surface on at least one side.

8. The invention of claim 6, wherein said rigid foam includes two laminate surfaces with a foam core sandwiched between.

9. The invention of claim 1, wherein said planar surface has a rough texture to facilitate adhesive attachment of objects to said surface.

10. The invention of claim 1, wherein said base includes a flat surface for mounting a nameplate.

11. A display kit comprising:
a base having a bottom, sidewalls integral with said bottom and a top integral with said sidewalls and presenting a planar surface,
said top and said sidewalls cooperating to form a channel around the perimeter of said surface;
a backboard adapted to be received in said channel on at least three sides of said base,
said backboard being foldable into a planar configuration and having a width greater than the width of said channel, and being wedged into said channel,
said backboard comprising a material which can be cut with a knife to present a desired configuration.

12. A display kit comprising:
a base presenting a planar surface;
a backboard adapted to be coupled with said base on at least three sides while being foldable into a planar configuration;
means integral with said base for securing said backboard to said base.

13. The invention of claim 12, wherein said backboard has at least two lines of weakness to accommodate folding into said planar configuration.

14. The invention of claim 13, wherein said backboard is rigid.

15. A method of constructing a display from a base and a backboard that is initially folded in a flat configuration, said method comprising:
placing the base on a flat surface;
at least partially unfolding the backboard to conform to the configuration of the base on at least three sides; and
securing the backboard to the base without the use of external fasteners.

16. The method as set forth in claim 15, wherein said unfolding step comprises unfolding said backboard onto a flat surface and cutting said backboard to a desired configuration with a knife.

17. The method as set forth in claim 16, wherein said base presents a channel which is narrower than the width of said backboard and said securing step comprises wedging said backboard into said channel.

18. The method as set forth in claim 17, wherein said base presents a planar surface having a rough texture and wherein is included the step of adhesively securing an object to be displayed to said surface.

19. The method as set forth in claim 16, wherein said backboard presents a form for a diorama which is partially constructed from a flowable material and wherein is included the step of placing said flowable material onto said base.

20. The method as set forth in claim 15, wherein said display is constructed from a kit which includes said base and said backboard in a unitary package.
